(19) United States
(12) Patent Application Publication
(10) Pub. No.: US 2004/0219972 A1
(43) Pub. Date: Nov. 4, 2004

(54) Complex system of providing gambling games

(76) Inventor: Varga Zdenek, Praha (CZ)

Correspondence Address: BANNER & WITCOFF, LTD., 28 STATE STREET, 28th FLOOR, BOSTON, MA, 02109-9601, US

(21) Appl. No.: 10/823,501

(22) Filed: Apr. 13, 2004

(30) Foreign Application Priority Data
Apr. 14, 2003 (CZ) PUV 2003-14155

(51) Int. Cl. G06F 17/00; G06F 19/00

(52) U.S. Cl. 463/25

(57) ABSTRACT

Disclosed is a system for providing a complex gambling environment based on the application of electronic data transfer in the GSM network with automated data processing, characterized in that a GSM phone station (1.1) is connected with a gambling credit system (2.1) of a GSM provider (2), connected with a gambling system (3.1) of gambling provider (3) and a prize and winnings accounting system (3.2) and also comprises a single-purpose single-action gambling voucher for winnings transfer into the gambling credit system (2.1).

### PRIORITY CLAIM

This application claims priority from Application No. PUV 2003-14155 filed in the Czech Republic on Apr. 14, 2003, the disclosure of which is hereby incorporated herein by reference.

### FIELD OF INVENTION

The present invention concerns a complex system of providing a complex gambling environment based on the application of electronic data transfer in the GSM network with automated data processing.

### BACKGROUND OF THE INVENTION

Gambling has been provided up to now in special public sites equipped with gambling machines, or with personal presence of the gambler and of the gambling provider. Other versions of gambling are mediated by stake agents, so-called legal or illegal bookmakers. A serious limitation of the gambling machine operation is the necessity of the physical presence of the gambler; the limitation of stake systems is the fixed periodicity of the action.

The GSM network (GSM stands for Global System for Mobile Communications) was developed in response to a need for a system, which could be used all over Europe and would allow its users to receive and make calls from a number which was not attributable to any geographical area. The GSM system was designed to also enable the customer to be billed by just one operator and pay for only one line rental.

GSM is the most widespread mobile system and is now used by more than 50% of the phones worldwide, which was largely as a result of early standardisation by the European authorities. It is available in over 140 countries, although there are now four different frequencies upon which it operates; 450, 900, 1800 and 1900 MHz.

GSM is the European and UK standard. GSM 900 is a mobile phone standard established mainly in Europe, South East Asia, Australia and Africa. This means that travellers can roam in around 140 countries with the same phone.

GSM Coverage

| | | |
|---|---|---|
| Albania | Guernsey | Oman |
| Algeria | Hong Kong | Pakistan |
| Andorra | Hungary | Palestine |
| Armenia | Iceland | Paraguay |
| Australia | India | Philippines |
| Austria | Indonesia | Poland |
| Azerbaijan | Ireland | Portugal |
| Babrain | Isle of Man | Qatar |
| Bangladesh | Israel | Romania |
| Belarus | Italy | Russia |
| Belgium | Jamaica | Rwanda |
| Bermuda | Jersey | Saudi Arabia |
| Bosnia and Herzegovina | Jordan | Senegal |
| Botswana | Kazakhstan | Seychelles |
| Brunei | Kenya | Singapore |
| Bulgaria | Kuwait | Slovenia |
| Burundi | Kyrgyz Republic | Slovenia |
| Cambodia | La Reunion | South Africa |
| Cameroon | Latvia | Spain |
| Cape Verde | Lebanon | Sri Lanka |
| China | Liechtenstein | Sudan |
| Congo | Lithuania | Suriname |
| Cote d'Ivoire | Luxembourg | Swaziland |
| Croatia | Macau | Sweden |
| Cuba | Macedonia | Switzerland |
| Cyprus | Madagascar | Syria |
| Czech Rep. | Malawi | Taiwan |
| Denmark | Malaysia | Tanzania |
| Dominican Republic | Maldives | Thailand |
| Egypt | Malta | Togo |
| Equatorial Guinea | Mauritius | Tunisia |
| Estonia | Moldova | Turkey |
| Faroe | Monaco/Kosovo | Turkmenistan |
| Fiji | Mongolia | UAE |
| Finland | Montenegro | Uganda |
| France | Morocco | Ukraine |
| Georgia | Mozambique | Uzbekistan |
| Germany | Namibia | Vietnam |
| Ghana | Nepal | Yemen |
| Gibraltar | Netherlands | Yugoslavia |
| Greece | New Zealand | Zambia |
| Greenland | Nigeria | Zimbabwe |
| Guadeloupe | Norway | |

### SUMMARY OF THE INVENTION

The limitations of the known gambling systems can be overcome by the present invention, which comprises a system of providing gambling games, based on the technical principle of electronic data transfer supported by GSM providers, characterised in that the GSM station user, being a participant of a gambling credit system at the GSM provider, co-operates with the gambling system provider, the gambling system being further being supported by a prize and winnings accounting system.

In preferred embodiments, the system of the present invention is based on a single-purpose single-action gambling voucher permitting to transfer the participant's stake into the gambling credit fund.

In preferred embodiments, the gambling system also comprises a current credit account also displaying the prize winnings on the GSM phone display.

In preferred embodiments, the prize winnings display system is connected with the current gambling credit in order to transfer the winnings to the current gambling credit amount which is further compatible with the calling credit in that the winnings can be transferred onto the calling credit at the GSM provider and connected by a port with the gamblers banking account permitting to transfer the winning onto said account. If a computer is used, the connection with the provider is over the Internet system.

The basic merit of the system of the present invention is the ability to gamble anywhere and any time. The gambling credit voucher application allows the gambler to read the total sum of money invested in gambling at any given time.

While the GSM network is the preferred network of the present invention, other cellular telephone and/or satellite telephone networks can be employed in the invention in the same manner as the GSM network.

### BRIEF DESCRIPTION OF THE DRAWINGS

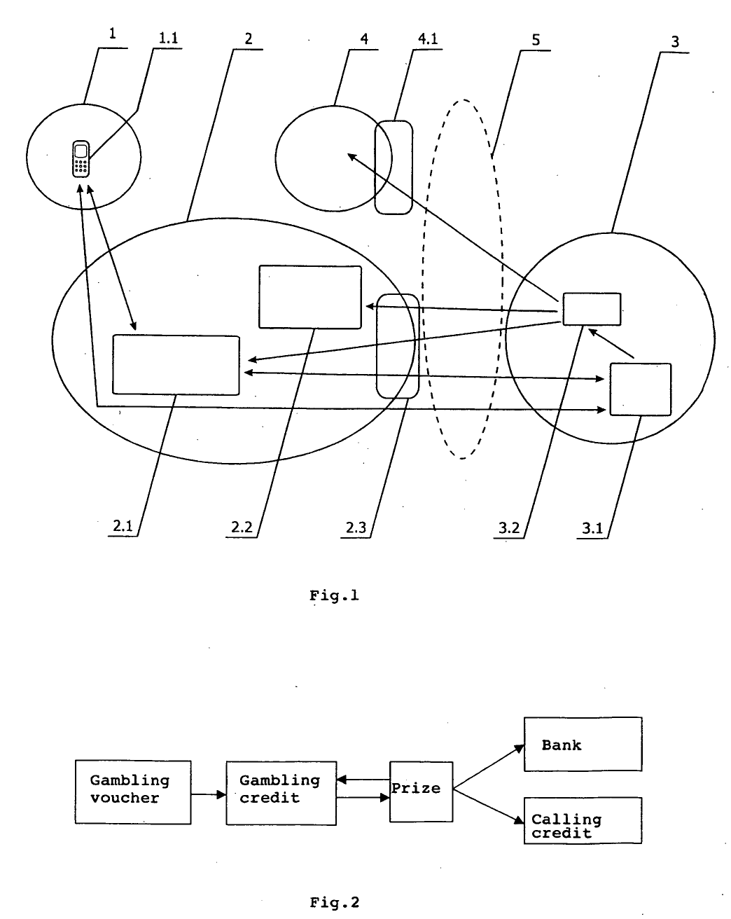

In FIG. 1, the principles of the present invention are illustrated in schematic form.

In FIG. 2, a cash flow system is illustrated.

### DETAILED DESCRIPTION OF THE INVENTION

The present invention comprises a system for providing a complex gambling environment based on the application of electronic data transfer in the GSM network with automated data processing, characterized in that a GSM phone station (1.1) is connected with a gambling credit system (2.1) of a GSM provider (2), connected with a gambling system (3.1) of gambling provider (3) and a prize and winnings accounting system (3.2) and also comprises a single-purpose single-action gambling voucher for winnings transfer into the gambling credit system (2.1).

Referring to the Figures we see that the present invention provides a complex system of providing gambling games and includes the following interconnected components—the gambling subject or participant 1, the GSM provider 2, the gambling provider 3, and the bank 4.

The gambling provider 3 provides the gambling system 3.1 and the prize and winnings accounting system 3.2.

The GSM provider 2 provides a calling credit system 2.2 and a gambling credit system 2.1.

To transfer the data the participant 1 is connected with a gambling credit system 2.1 of a GSM provider 2 by means of a GSM phone station 1.1 and also a gambling system 3.1 of gambling provider 3. The gambling system 3.1 is connected with a prize and winnings accounting system 3.2 and via a port 2.3 with the gambling credit system 2.1. The prize and winnings accounting system 3.2 is connected via a port 2.3 with the gambling credit system 2.1, with a calling credit system 2.2 and via a port 4.1 it is connected with the bank 4. The Internet 5 can be used to connect the gambling provider 3 with a GSM provider 2.

The game is started by the participant 1 by inserting the number of a single-purpose single-action gambling voucher, using a special sequence of keypad instructions via the GSM phone station, into the gambling credit system 2.1, which initiates the connection with the gambling provider 3, who registeres the participant 1 under the number of his GSM phone station 1.1 and offers him a list of games.

After the selection of a game is made by a participant 1, a chosen program is recorded into his GSM phone station 1.1 in Java language graphically displaying symbols of the game and the amount of the game credit. The participant 1 selects the amount and the type of the bet and introduces it into the gambling system 3.1.

Information on any prize winnings is transferred from the gambling system 3.1 into a prize and winnings accounting system 3.2 and a GSM phone station 1.1 of the participant 1 by means of the device evaluating the amount of the winnings. Based on the participant's decision, the prize winnings are transferred either into a gambling credit system 2.1 or a calling credit system 2.2 or into the bank 4—e.g., into the participant's 1 bank account.

In case of a zero balance in the gambling credit system 2.1, the participant 1 can start another game by entering the number of a new gambling voucher.

The present invention has been described in detail, including the preferred embodiments thereof. However, it will be appreciated that those skilled in the art, upon consideration of the present disclosure, may make modifications and/or improvements on this invention and still be within the scope of this invention as set forth in the following claims.

What is claimed is:

1. A complex system for providing a complex gambling environment based on the application of electronic data transfer in the GSM network with automated data processing, characterized in that a GSM phone station (1.1) is connected with a gambling credit system (2.1) of a GSM provider (2), connected with a gambling system (3.1) of gambling provider (3) and a prize and winnings accounting system (3.2) and also comprises a single-purpose single-action gambling voucher for winnings transfer into the gambling credit system (2.1).

2. A complex system according to claim 1, characterized in that the gambling system (3.1) comprises a current account of the gambling credit and prize amount, the output of said system being displayed on the screen of the GSM phone station (1.1).

3. A complex system according to claim 1, characterized in that the prize and winnings accounting system (3.2) is connected with the gambling credit system (2.1) permitting a transfer of the prize onto the gambling credit, and with a calling credit system (2.2) at the GSM provider (2) permitting to transfer a prize onto the calling credit and further over port (4.1) with a bank (4) permitting a transfer of the prize onto the account of the participant at the bank (4).
